(19) United States
(12) Patent Application Publication
(10) Pub. No.: US 2012/0259721 A1
(43) Pub. Date: Oct. 11, 2012

(54) System for Dynamically Pricing Tickets and Goods Through Reciprocal Dialogue and Conditions

(75) Inventor: Michael J. De Angelo, Palm Springs, CA (US)

(73) Assignee: Incandescent, Inc.

(21) Appl. No.: 13/442,400

(22) Filed: Apr. 9, 2012

Related U.S. Application Data
(60) Provisional application No. 61/473,688, filed on Apr. 8, 2011.
(60) Provisional application No. 61/476,689, filed on Apr. 18, 2011.

(51) Int. Cl. G06Q 30/00

(52) U.S. Cl. 705/26.1

(57) ABSTRACT

A software apparatus existing on a network or network device or devices enabling buyers or their representation and sellers or their representation to engage in network-mediated dialogue regarding pricing for good and services, and to conclude a purchase or sale based upon that dialogue. The price can be dynamically adjusted based on profit optimization for the seller or cost minimization for the buyer. Alternatively or additionally, the price can be adjusted based upon the time of day or window of time, distance from the seller, one or more locales, aggregated and averaged buy offers from buyers, marketing analytics, or external world conditions.

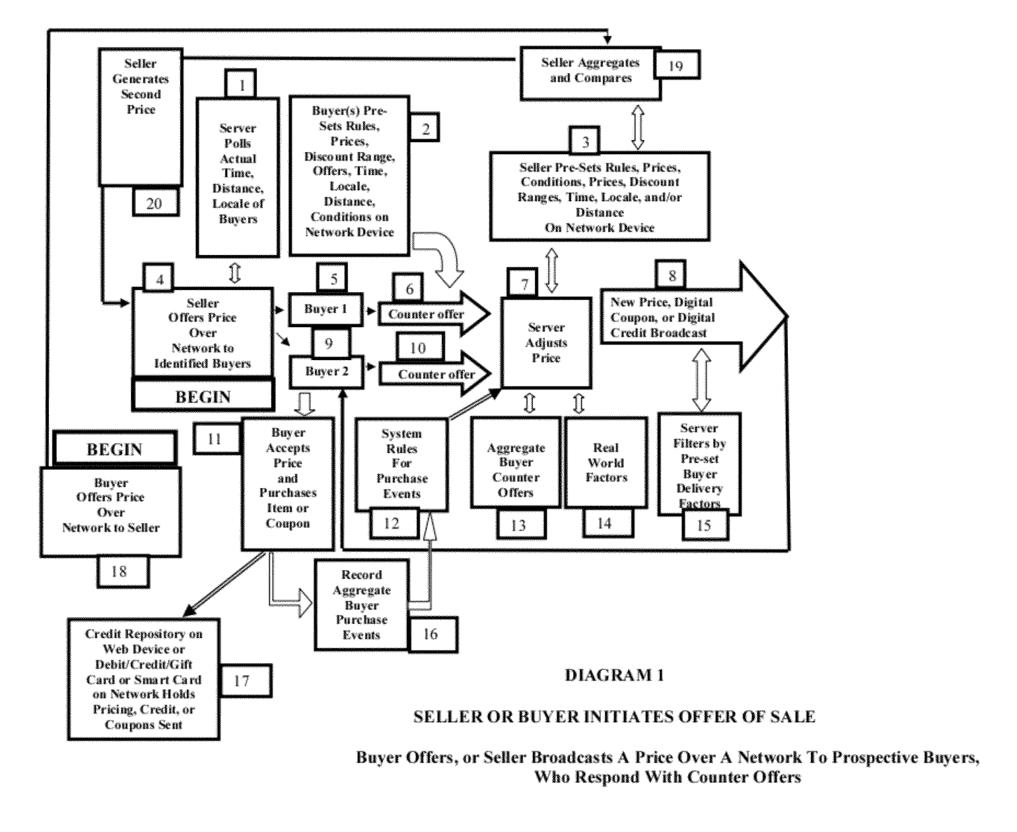

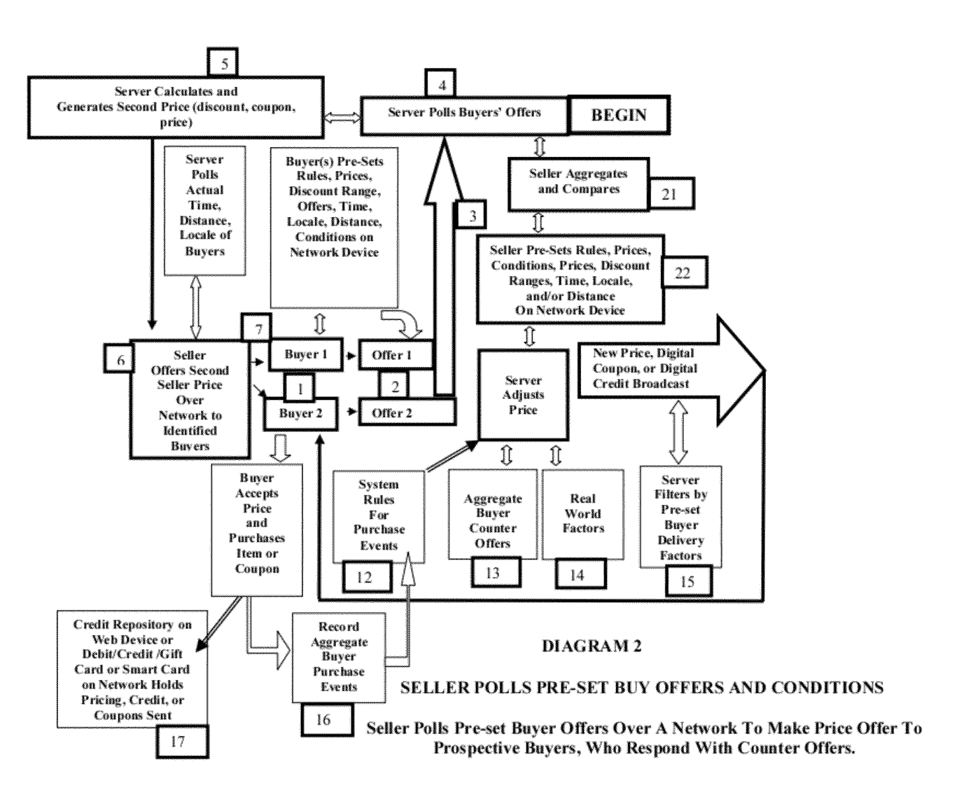

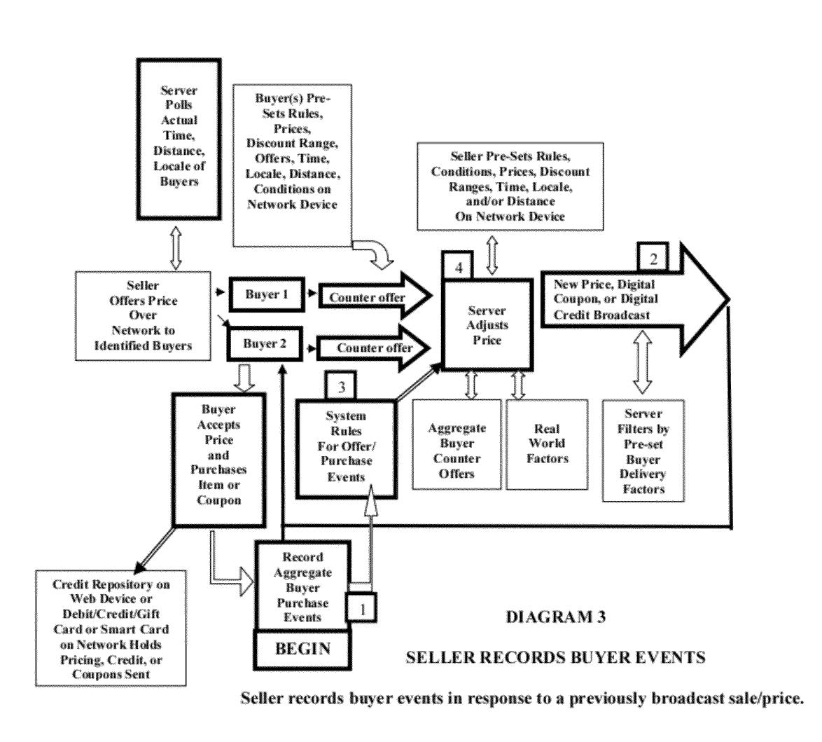

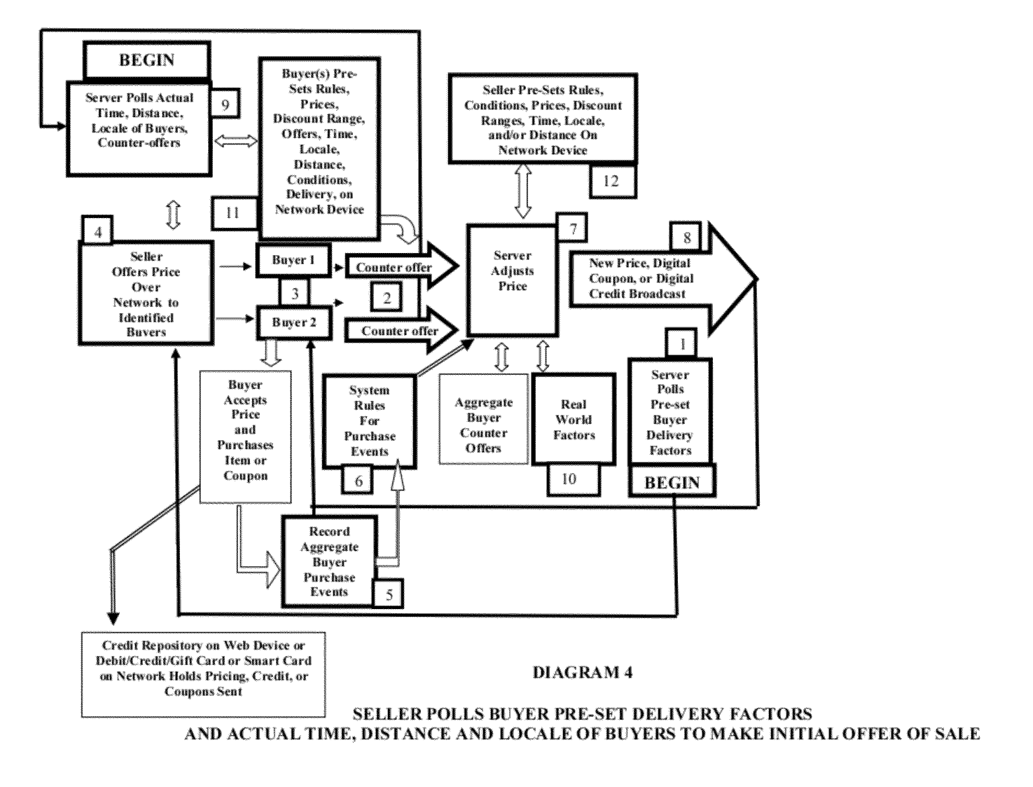

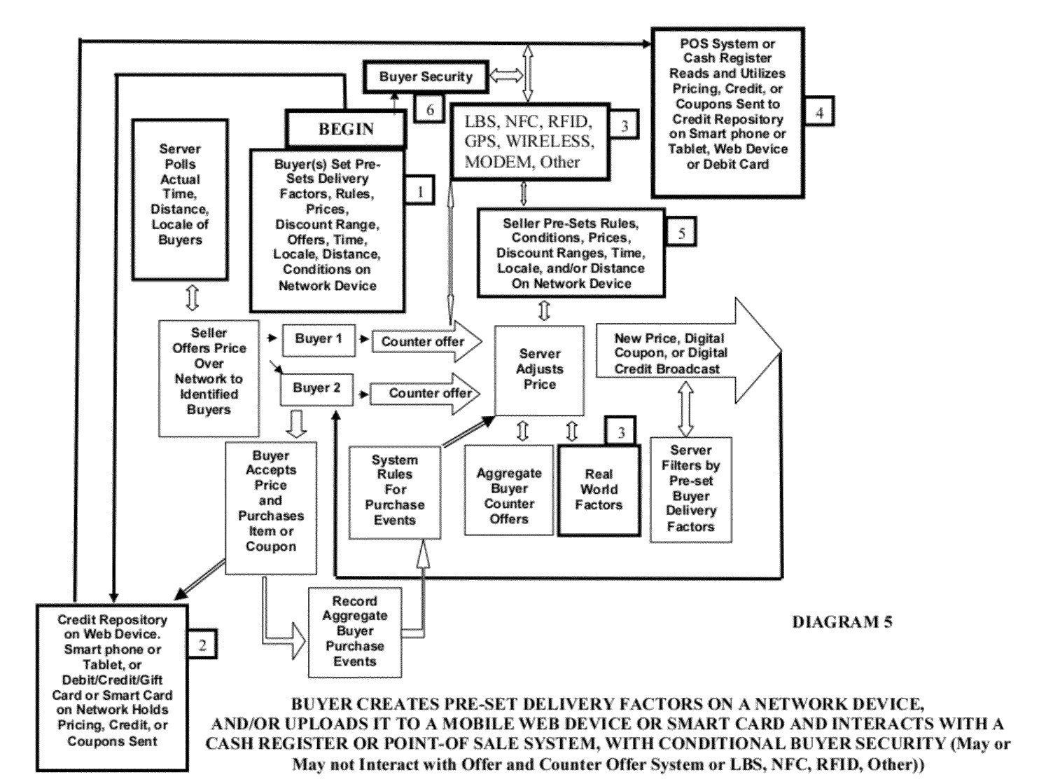

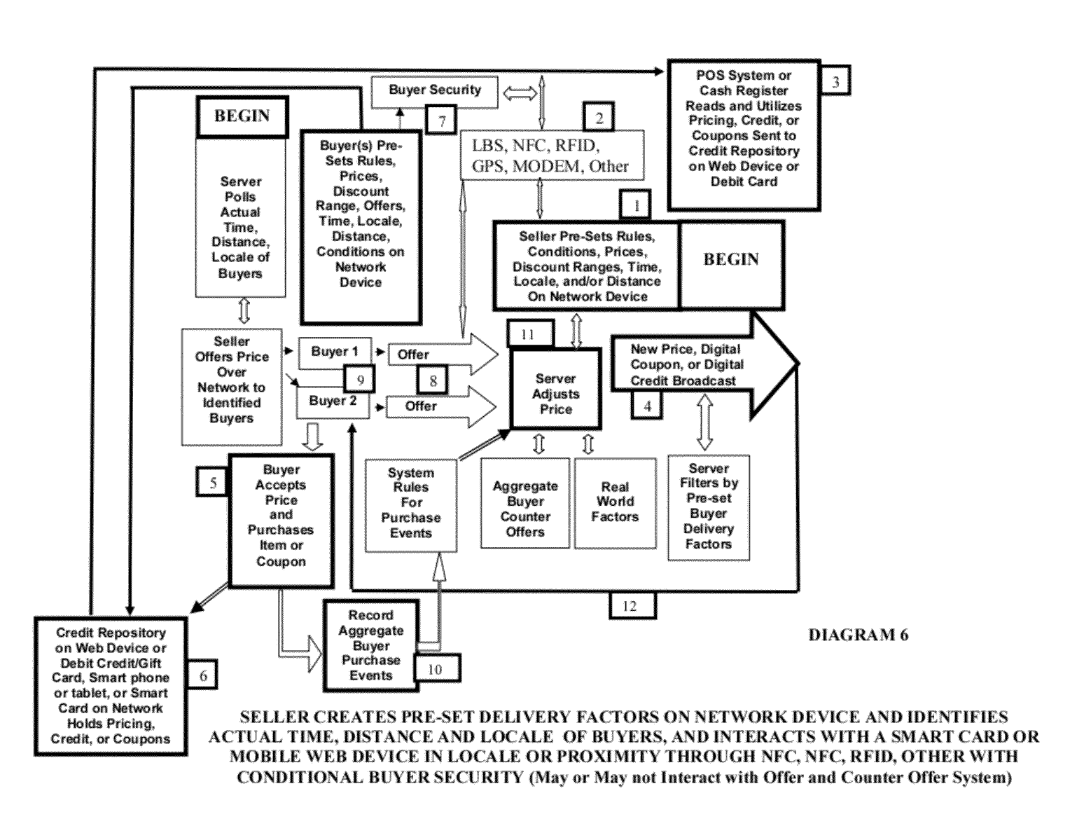

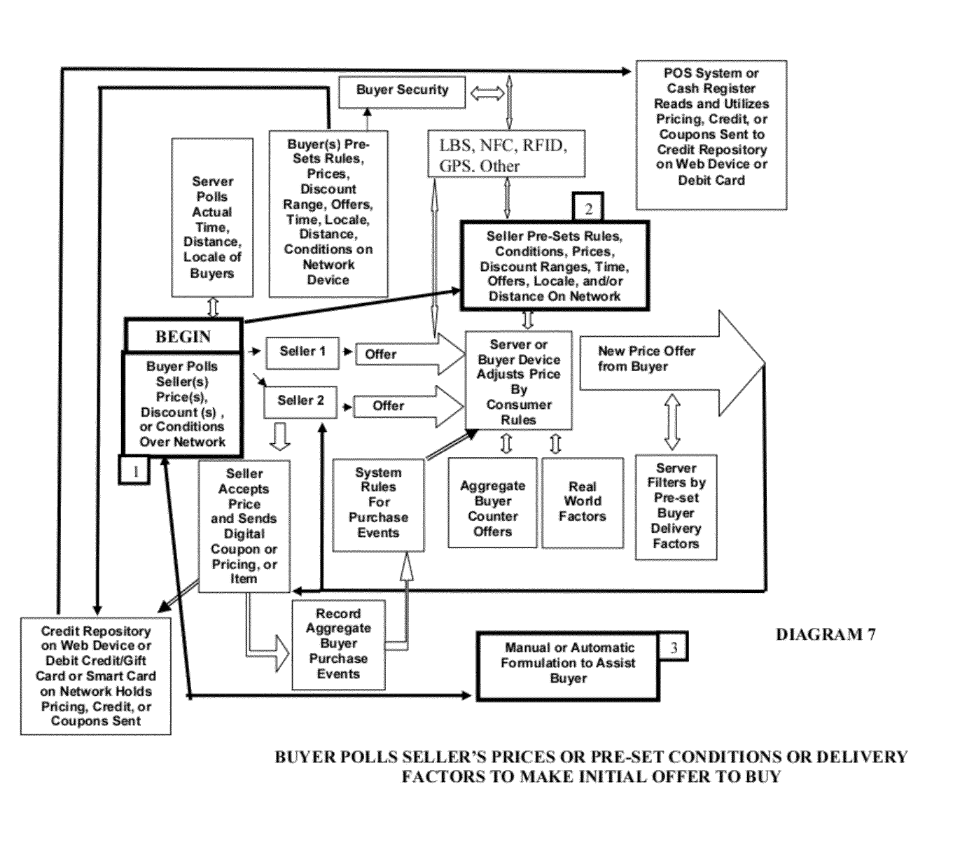

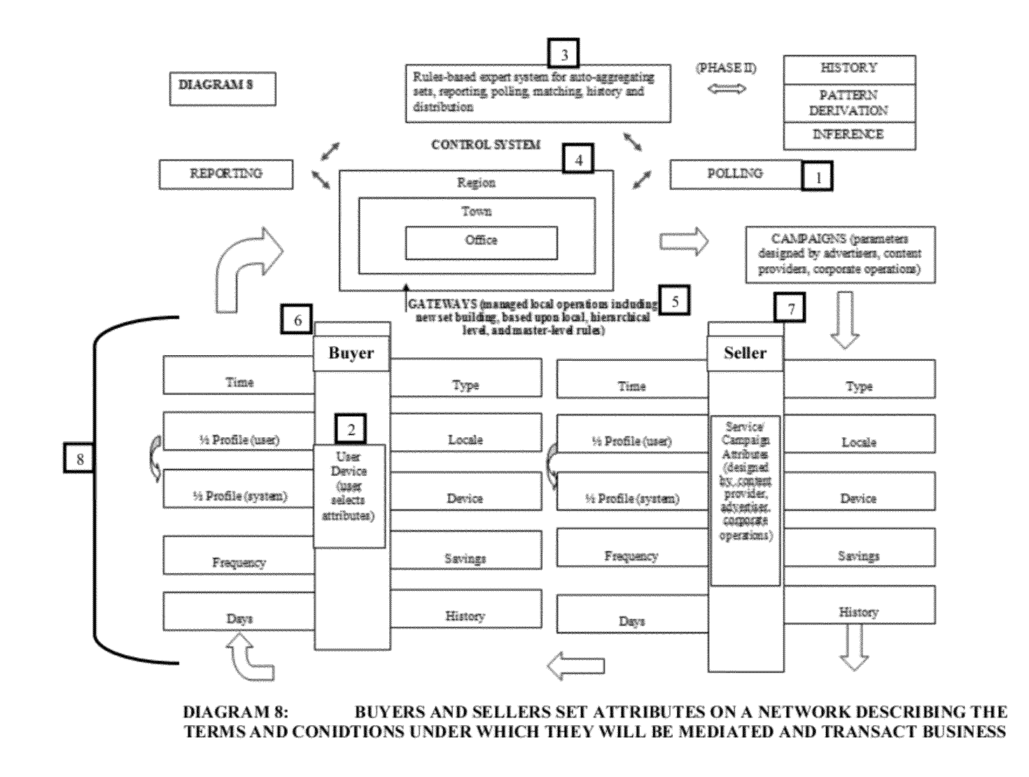

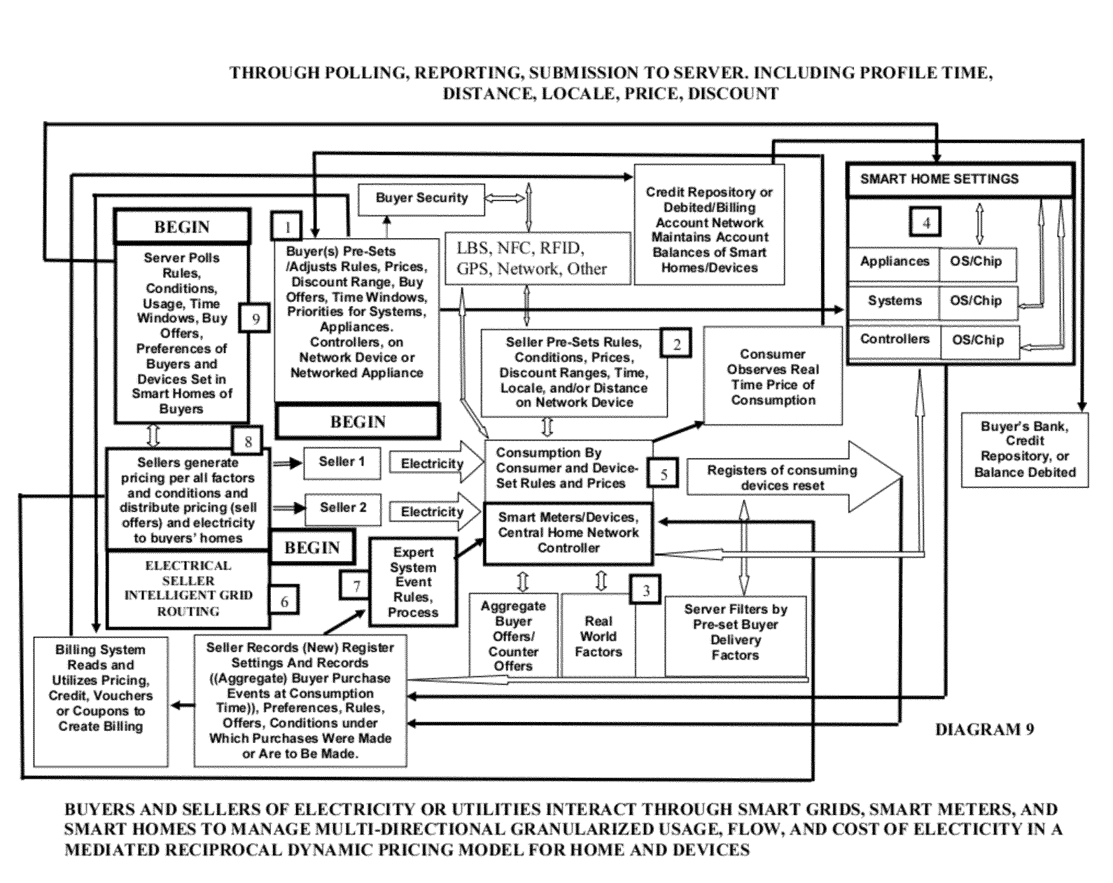

### CROSS REFERENCE TO RELATED APPLICATIONS

This application claims priority to U.S. provisional patent application Ser. No. 61/473,688 filed Apr. 8, 2011, and which claims priority to U.S. provisional patent application Ser. No. 61/476,689 filed Apr. 18, 2011. Priority to the provisional patent applications are expressly claimed, and the disclosure of the provisional applications are hereby incorporated herein by reference in its entirety and for all purposes.

### BACKGROUND

The present disclosure generally relates to sales, couponing, and purchasing systems, and more specifically, but not exclusively, concerns a sales system adapted to dynamically price goods and/or services over a computer network through system-mediated dialogue around pricing, terms and conditions.

There exists a need to provide buyers and sellers with a more interactive way to engage in negotiations for a product purchase that allows for reciprocal dialogue between the buyer and seller, whatever the duration, steps, or method required to complete such a dialogue to conclusion. There is also a need for a system where buyers or aggregated buyers can obtain best pricing, including, but not limited to, a kind of collective bargaining session over mobile devices. A need also exists for a system wherein sellers can view buyer interest and offers and respond to that buyer interest, or receive dynamic pricing guidance in order to more effectively capture buyer surplus.

### SUMMARY

A system for dynamically pricing tickets and goods is operatively coupled to one or more buyers and their expression and the person or the expression of one or more sellers over a network. The system dynamically adjusts pricing of tickets and goods and delivers pricing, digital tickets or coupons to the buyers and closes sales, in part by continuously polling buyer purchases, preferences, and buy offers.

The price can be dynamically adjusted based on profit optimization or cost minimization for the seller or the buyer. Alternatively or additionally, the price can be adjusted based upon the time of day or window of time, distance from the seller, one or more locales, aggregated and averaged buy offers from buyers, or external world conditions. Further, the system is capable of observing all human editing or choices by buyers or sellers, in response to a first offer to buy, or to sell, or an offer already mediated by a software system mediating between buyer and their expressions and seller or their expression.

### BRIEF DESCRIPTION OF THE DRAWINGS

Diagram 1 illustrates a flow diagram of a seller or buyer initiated offer of sale using the system and methods of the present disclosure commencing with a seller or buyer offering a price over a network to identified buyers or sellers

Diagram 2 illustrates a flow diagram: Seller polls pre-set buyer offers over a network to make price offer to prospective buyers, who respond with counter offers.

Diagram 3 illustrates a flow diagram: Seller records buyer events in response to a previously broadcast sale/price.

Diagram 4 illustrates a flow diagram: Seller polls buyer pre-set delivery factors and actual time, distance and locale of buyers to make initial offer of sale.

Diagram 5 illustrates a flow diagram: Buyer creates pre-set delivery factors on a network device, and/or uploads it to a mobile web device or smart card and interacts with a cash register or point-of sale system, with conditional buyer security. Diagram 6 illustrates a flow diagram: Seller creates pre-set delivery factors on network device and identifies actual time, distance and locale of buyers, and interacts with a smart card or mobile web device, Smart phone or tablet, in locale or proximity through NFC, NFC, RFID, or other with conditional buyer security.

Diagram 7 illustrates a flow diagram: Buyer[s] poll seller[s] prices and/or seller pre-set conditions or delivery factors to make initial offer to buy.

Diagram 8 illustrates a flow diagram: Buyers and sellers set attributes on a network describing the terms and conditions under which they will be mediated and transact business through polling, reporting, and submission to server including profile time, distance, locale, price, discount.

Diagram 9 illustrates a flow diagram: Buyers and sellers of electricity or utilities interact through smart grids, smart meters, and smart homes to manage multi-directional granularized usage, flow, and cost of electricity in a mediated reciprocal dynamic pricing model for home and devices.

### DETAILED DESCRIPTION

One form of the present disclosure concerns a unique digital seller-buyer system-mediated reciprocal dialogue pricing, couponing and purchasing system over a network. Exemplary embodiments of the present disclosure are shown in the attached Diagrams. The process flow is similar across many of the Diagrams, but the initial input or starting point of the process varies. As sellers and buyers interact with information from one or more counterparts [seller to buyer, buyer to seller], or interact with information after it has been mediated between the parties by the expert system that the system observes, tracks, and correlates that information. While correlating, it builds historical usage and response patterns, and makes inferences to build, or assist human editors in building, new rules for the expert system for refining the pricing process. The pricing process includes mediating terms, conditions, and pricing between buyers and sellers and delivering digital coupons, digital tickets, digital price changes, and digital goods. In another form, sellers observe through polling or receiving reports on a network the settings and interactions of one or more buyers entering preference or profile information. This information would include one or more of the following: time or window of time, locale, distance from sellers or range of radius from seller, offers to buy, price, discount level, or variance from discount level. This information would normally be associated with a device type, where that device type might be read automatically, along with identification information that would normally be associated with a personal profile.

In one method, an expert system might manage this information in slices of time and locale, polling or reporting information to successively more inclusive or less inclusive sets.

One exemplary method. As shown in Diagram 8, of correlating this information is to build it in [4] hierarchical sets at levels of distance [radius] or time window [radius of time from exact designated time] using [3] rules for auto-aggregation and gateways through which profiles with metadata pass. In this case, gateways at each level might also maintain activity logs of profiles and activity associated with that level. One profile can exist in more than one level because each level is inclusive of the level below it. In the following embodiments, “price” or “pricing” is meant to indicate any means of creating value or incentive or accomplishing effective pricing whether directly or indirectly, or through promotion, discount, coupon, including but not limited to the value of time and locale as effectively employed.

1. Offers Sent as First Step

In one embodiment, a as shown in Diagram 1, a first offer price for a ticket, coupon, or item that one or more buyers hope to buy [18] is sent over a network by buyers to a central server. Buy offers for the item at the first price are received from the buyers, and compared, or [19] aggregated and compared to a [3] second price set by a seller on the server. The server prices the item at a [20] second seller price based at least on one buy offer from a buyer, and the second seller price in the form of a digital ticket, price or coupon is [4] sent over the network to the buyers. Alternately, the processor can send a digital coupon to achieve the same end result in a pricing offer to achieve this process.

The following process as shown in Diagram 1 comprises a circuit that may be initiated from various starting points, and with variable complete or partial paths through the circuit any of which might result in a responsive offer to a prospective buyer or buyers. The process would be integrated into a computer algorithm or combination of algorithms executed in software of firmware. Seller [4] broadcasts a price over a network to one or more buyers [5] [9] who may have been indentified by opting into an initial solicitation or by [1] polling the time, distance, or locale of prospective buyers or by identifying buyers who have [2] pre-set rules, prices, receptivity criteria, discount range, offers, time, locale, distance, conditions on network devices. A server [7] adjusts the price based upon [2] those buyer pre-set rules in combination with [3] pre-set rules, prices, receptivity criteria, discount range, offers, time, locale, distance, conditions set by one or more sellers on the network. The [5] one or [9] more buyers respond[s] with a counter offer [6] [10], in some cases using a [8] new price, digital coupon, or digital credit broadcast sent directly to a mobile device or to [17] a credit repository on a network device or debit/credit /gift card, or Smart phone or tablet, or Smart card on a network that holds pricing, credit, or coupons sent. In an advanced case, the counter offers [6] [10] are based on [either solely or in combination with other factors] one or more of [12] system rules for offer and purchase events, such as [1] actual time, distance, or locale of buyers. In further embodiments, the counter offers [6] [10] can be based on [either solely or in combination with other factors] [13] aggregate buyer analysis, [14] real world factors, and/or [15] pre-set filters regarding delivery. The objective of the system is to have one or more buyers utilize the offer to make a purchase [11], while [16] tracking those purchase events.

B. Polling of Buy Offers as First Step

In another embodiment, as shown in Diagram 2, a server polls he first price [4] of an item [1] one or more buyers offer to buy and an [2] acceptable variance in percentage or amount that has been sent or collected [3] sent over a network to a central server or established on one or more buyers' devices in a manner that might be [4] polled by the server. Buy offers for the item at the first price are received [5] from the buyers, and [21] compared, or aggregates and compared to a [22] conditions established by a seller on the server. The server accepts the offer or [5] prices the item at a second seller price based at least on one buy offer from a buyer, or at least one acceptable variance in percentage or amount indicated by the buyer, and the second seller price [5] [6] is sent [7] in the form of a [5] digital ticket, price or coupon over the network to the buyers. Alternately, the processor can send a digital coupon to achieve the same end result of pricing offer to achieve this process.

The above is accomplished when a computer readable device is encoded with a program executable by a computer. As shown in Diagram 2, the program is executable to poll for a first price of an item a buyer has offered. After a price adjustment of zero or more, the program delivers the pricing or coupon, or delivers the pricing or coupon based upon the buyer's stated preference for a time or window of time for that delivery, and/or based upon buyer's stated preference for a specified locale, however specified, and/or based upon the buyer's stated preference for a specified distance or range of distance from the seller.

The price adjustment made by the server can be based on a variety of factors either alone or in combination. For example, the server can calculate the pricing adjustment based upon a distance or range of distance between the buyer and the seller. In another example, the server calculates the pricing adjustment based upon a time of day, window of time, or real world factors.

C. Recording of Purchases, Price Adjustment and Delivery

In another embodiment shown in Diagram 3, price adjustments are made based on aggregated records of buyer's or buyers' purchases. The following are provided as non-limiting examples of processes:
1. the server records [1] the time between purchases, adjusts the price [4], and sends out [2] a new price only if [3] the buyer is within a seller-stated preferred time or window of time.
2. the server records [1] the time between purchases, adjusts the price [4], and sends out a new price [2] only if [3] the buyer is within a seller-stated preferred locale.
3. the server records the time between purchases [1], adjusts the price [4], and sends out a new price [2] only if [3] the buyer is within a seller-stated preferred distance or range of distance from the seller.
4. the server records [1] the number of purchases, adjusts the price [4], and sends out a new price [2] only if [3] the seller is within a buyer-stated preferred time or window of time.
5. the server records [1] the number of purchases, adjusts the price [4], and sends out a new price [2] only if [3] the seller is within a buyer-stated preferred locale.
6. the server records [1] the number of purchases, adjusts the price [4], and sends out a new price [2] only if [3] the seller is within a buyer-stated preferred distance or range of distance from the buyer.
7. the server records [1] the percentage of purchases compared to offers sent out, adjusts the price [4], and sends out a new price [2] only if [3] the buyer is within a seller-stated preferred time or window of time.

8. the server records [1] the percentage of purchases compared to offers sent out, adjusts the price [4], and sends out a new price [2] only if [3] the buyer is within a seller-stated preferred locale.

9. the server records [1] the percentage of purchases compared to offers sent out, adjusts the price [4], and sends out a new price [2] only if [3] the buyer is within a seller-stated preferred distance or range of distance from the seller.

D. Polling and Recording of Offers by Time or Distance or Locale

In another embodiment, as shown in Diagram 4, the process starts [1] with the server polling [9] [11] the buyer's or buyers' pre-set delivery factors such as delivery time, locale, or distance. One or more factors can be analyzed together, or a single factor can be used. For example, in this process, 1) the server polls and records [9] the actual time or window of time of any counter-offer [2] offered by a buyer or buyers [3] over the network 2) the server polls and records the [9] actual locale of any counter-offer offered by a [3] buyer or buyers over the network; and/or 3) the server polls and records the [9] actual distance or range of distance from the seller of any [2] buyer counter-offer offered by a buyer or buyers over the network.

E. When Server/Seller Initiated the First Offer

In another embodiment, as shown in Diagram 4, the seller initiates the first offer [4] to a buyer before a buyer counter-offer is sent back to the server, and a seller counter offer [8] to the buyer counter-offer is sent back to the buyer over the network. In an alternative embodiment, the server can initiate the offer, and there is no counter-offer.

In another embodiment, as shown in Diagram 4, the server records the time between purchases [5], adjusts the price [7], and sends out a new price [8] only if [6]: 1] the buyer is within a buyer-stated preferred time or window of time; 2] the buyer is within a buyer-stated preferred locale; and/or 3] the buyer is within a buyer-stated preferred distance or range of distance from the seller.

In another embodiment, the server records the number of purchases [5], adjusts the price [7], and sends out a new price [8] only if 1) the buyer is within a buyer-stated preferred time or window of time; 2) the buyer is within a buyer-stated preferred locale; and/or 3) the buyer is within a buyer-stated preferred distance or range of distance from the seller.

In another embodiment, the server records the percentage of purchases compared to offers sent out, adjusts the price [7], and sends out a new price [8] only if one or more of the following conditions are met: 1) the buyer is within a buyer-stated preferred time or window of time; 2) the buyer is within a buyer-stated preferred locale; and/or 3) the buyer is within a buyer-stated preferred distance or range of distance from the seller.

F. Polling and Recording of Time, Locale and Distance of Counter-Offers Made

In another embodiment, as shown in Diagram 4, the process includes the server [9] polling or recording information concerning the [2] counter-offers made by the buyer(s). For example, the server polls or records [9] one or more of the following information elements: 1) the actual time or window of time of any counter-offer offered by a buyer or buyers over the network; 2) the actual locale of any counter-offer offered by a buyer or buyers over the network; 3) the actual distance or range of distance from the seller of any counter-offer offered by a buyer or buyers over the network; 4) the seller-stated [12] preferred time or window of time of any counter-offer made by a buyer over the network to determine if the new pricing can be met and offered to the buyer over the network; 5) the locale or seller-stated preferred locale of any counter-offer by a buyer over the network to determine if the new pricing can be met and offered to the buyer over the network; 6) the seller-stated [12] preferred distance or range of distance from the seller of any counter-offer by a buyer over the network to determine if the new pricing can be met and offered to the buyer over the network. Using one or more of these elements, the server polls the seller-stated minimum discount or range of discount in order to determine if the new pricing can be met and offered to the buyer over the network.

G. Additional Price Adjustments

Real world factors [10] and other factors can also be used by the server to make price adjustments. The following exemplary factors may be used, either in combination or alone, by the server to make price adjustments: 1) live price of a publicly traded stock of the buyer and/or seller by finding that price over a computer network 2) any stock in the general field of the ticket, coupon, or item 3) live price of crude oil or gold or any publicly observed financial index by finding that price over a computer network 4) live price of one or more commodities by finding that price(s) over a computer network 5) the weather for the buyer or seller's locale and any intervening shipping routes by finding or more weather reports over a computer network 6) Any of the above in combination.

H. Embodiments Using Point-of-Sale Systems

In a further exemplary embodiment, as shown in Diagram 5, the buyer's [1] preferences can be inputted on a [2] Smart phone or tablet, smart card or web-enabled device. The smart card or web-enabled device can then be used at a [4] point-of-sale system [POS], cash register, television, interactive television, Internet television, and IPTV, or other system to process transactions. These can interact with [3] Near-Field Communications or Services [NFC, NFS] or Location Based Services [LBS] through RFID or other technology when that device is within proximity. As shown in Diagrams 5 and 6, the process preferably includes a [Diagram 5] [6] [Diagram 6] [7] conditional security step to prevent the use of counterfeit smart cards, hacking, and the like.

In one embodiment, as shown in Diagram 5, a buyer creates [1] pre-set delivery factors and preferences for rules, time, locale, conditions of delivery of offers, coupons, or digital credits, distance from seller, minimum price or discount or discount ranges on a network device, and/or uploads it to a [2] mobile Web device or credit/debit/gift/ or smart card, or Smart phone or tablet that later interacts with a [4] smart cash register or smart point-of sale system with any [3] available communication technology to process and resolve coupons, credits or discount.

In another embodiment, as shown in Diagram 5, a buyer creates [1] pre-set delivery factors and preferences for rules, time, locale, and conditions of delivery of offers, coupons, or digital credits, distance from seller, minimum price or discount or discount ranges. This information can be provided on a network device and/or uploaded to a [2] mobile Web device or to a smart card, Smart phone or tablet. The buyer can then interact with a [4] smart cash register or smart point-of sale system with any [3] available communication technology to process and resolve coupons, credits or discount. The interaction can also occur through a location-based service when in general proximity, such as a block, or through a Near-Field-Communication, such as a supermarket aisle, or any combination of these systems. That set of factor and preference information interacts, or exchanges information, or is mediated with, corresponding categories of information [5] from a seller. In this embodiment, whether none, or some, or all of the information is exchanged and mediated is based upon conditions set by buyer. The conditions can include, for example, actual time and locale of buyer or seller, or distance between them.

In another form a seller, as shown in Diagram 6, creates [1] pre-set delivery factors and preferences for rules, time, locale, conditions of delivery of offers, coupons, or digital credits, distance from seller, minimum price or maximum discount or discount ranges on a network device, and/or [2] uploads it to a [3] Web device, smart cash register, smart Point-of-Sale system, or Near Field Communication or location-based communicating device to process and resolve coupons, credits or discount [11] [4] [5] for buyers.

In another embodiment, as shown in Diagram 6, a seller creates [1] pre-set delivery factors and preferences for rules, time, locale, conditions of delivery of offers, coupons, or digital credits, distance from seller, minimum price or discount or discount ranges on a network device, and/or [2] uploads it to a [3] smart cash register, smart Point-of-Sale system, or Near Field Communication or location-based communicating device and makes an offer on a network that is accepted by at least one buyer [5] who accepts it and retains it by means of a [6] Smart phone or tablet, Web device, Smart card, or digital repository. That accepted offer information interacts, or exchanges information, or is mediated with corresponding information from a seller [1]. The interaction can occur through a [3] smart cash register, smart point-of sale system, or [3] a location-based service [LBS] when in general proximity, such as a block, or through a Near-Field-Communication, such as a supermarket aisle, or any combination of these systems. In this form, whether none, or some, or all of the information is exchanged and mediated is based upon [1] conditions set by the seller. The conditions can include, for example, actual time and locale of buyer or seller, or distance between them.

The program is further executable to receive [8] one or more offers of differing price from the [9] buyers. The program [11] prices the item at a [4] second price based on the offers received, singularly or in aggregate, and sends [12] the second price or coupon to achieve that price to the buyers over the network.

In a further embodiment, a system includes memory containing at least one item and a processor operatively coupled to the memory. The processor is responsive to input over a network from one or more buyers. The processor is operable to dynamically adjust pricing of a digital ticket, coupon or item, and to deliver the price, digital ticket, or coupon from execution of process or memory to the [9] buyers that [5] order them at a dynamically adjusted price. A computer algorithm or combination of algorithms executed in software pr firmware would be used to accomplish one or more of the processes.

In another embodiment, an institutional network is operatively coupled to one or more buyers. The institutional network is operatively coupled to at least one server that supplies a digital ticket or coupon over the institutional network. Compensation is received for the media content supplied by the server to the buyers over the institutional network.

In a further embodiment, a device is encoded with a program executable by a computer. The program is executable to identify one or more buyers that purchase an item over an institutional network as members of an institution that operates the institutional network. The program rewards the institution based on the purchases of the members.

In another embodiment, as shown in Diagram 7, a buyer [1] is provided with a means of polling the offers and conditions [2] of a seller, having them presented, or analyzed and presented, and then [3] manually or automatically formulating an offer to buy.

In another embodiment, as shown in Diagram 8, sellers observe through polling [1] or receiving reports on a network the settings and interactions [2] of one or more [8] buyers. The buyer information can include [8] profile information, [2] device type information, information [8]regarding where that device type might be read automatically, time or window of time, locale, distance from sellers or range of radius from seller, offers to buy, price, discount level, or variance from discount level. The original information is uniquely associated with a device, and/or person, the [3] expert system manages this information in [4] slices of time and locale, polling or reporting information to [5] successively more inclusive or less inclusive sets.

As shown in Diagram 8, as sellers and buyers interact with information from one or more counterparts [6] [7] (seller to buyer, buyer to seller), or interact with information after it has been mediated between the parties by the [3] expert system, the system observes, tracks, and correlates that information, building historical usage and response patterns, and makes inferences to build, or assist human editors in building, new rules for the expert system.

As shown in Diagram 8, one method of correlating this information is to build it in [4] hierarchical sets at levels of distance [radius] or time window [radius of time from exact designated time] using rules for [5] auto-aggregation and gateways through which profiles with metadata pass where the gateway is at each level in order that the level be recognized and associated with a unique profile at that level. One profile [8] can exist in more than one level because each level is inclusive of the level below it.

In another embodiment, and as shown in Diagram 9, [1] buyers and sellers of electricity or utilities interact through [6] smart grids, smart meters, and [4] smart homes to manage multi-directional granularized usage, flow, and cost of electricity in a dynamic pricing model mediated by an [7] expert system based upon two-way communications between buyers and sellers about [9] [2] time, locale, conditions, and pricing for delivery of electricity. Buyer[s] [1] pre-set rules, prices, discount range, offers, time windows, and priorities for [4] homes, gardens, garages, interior, exterior, wings, rooms, or systems, appliances, and/or controllers, on [2] network devices, networked appliances, or on a central networked controller or computer system. Device settings [4] controls, preferences, offers, time windows, etc. may be stored in a [2] central network device, computer system, or on an individual device.

Similarly, sellers [2] may set [2] conditions, rules, preferences, and pricing for international, national, state, region, county, neighborhood, home, etc. considering all factors including but not limited to world conditions [3], market prices of gold and oil, and alternate energy forms such as coal, nuclear, solar, hydro, aggregate buyer's offers, delivery factors, weather, day of week, holidays, electrical market price, etc. The choices of both buyers and sellers may be governed and altered manually or automatically by interaction with one another, with the world, and world conditions such as the weather, the price of gold, the price of oil, the current market price of electricity, etc. Buyers may interact with more than one utility system by the hour or day.

Interaction with, and the electrical distribution to any device or condition and buy-offer set device can also be [5] governed or altered as to election of consumption, time, location of device or area of room, priority, and sequencing, based upon similar conditions, and upon the real-time distribution of electricity to other parts of the home or devices in the home, as to state of consumption, amount, cost, etc. Devices may communicate with a central networked controller that in turn communicates with [6] international, national, state, region, county, or neighborhood smart grids.

The system mediates a granular sequential step dialogue between buyer and seller, accounting for all of [9] buyers' and [2] seller's buy or sell offers, preferences, conditions, time windows, time of consumption, [3] world factors, delivery factors, price of electricity, weather, price of alternate energy, of gold, of oil, etc.

The processes described herein can further be used in conjunction with the teachings of issued U.S. Pat. No. 7,010,536, U.S. Pat. No. 7,702,682, U.S. Pat. No. 7,873,682, and U.S. Pat. No. 7,873,68, the disclosure of which are expressly incorporated herein by reference.

Other forms, embodiments, objects, features, advantages, benefits, and aspects of the present disclosure shall become apparent from the detailed drawings and description contained herein.

While the present invention has been described with reference to certain preferred embodiments, those skilled in the art will recognize that various modifications may be provided. Also, the physical computing infrastructure may be mainframe, mini, client server or other with various network and distributed computing designs, including digitally supported or based physical or public media, mobile computing devices, digital meters, or components supporting machine-to-machine communications, such that the described invention may comprise any variation distributed through device, network or space. Then various components and circuits may reside in a device, a combination of devices, or a network. The whole system may be hierarchically nested within other systems to the nth degree. The means of accomplishing price variation or dialogue may operate on a rules-based, fuzzy logic, artificial intelligence, neural net, or other system not yet devised. Also, hardware configurations may assume myriad forms without altering the essential operation of this invention. Other variations upon and modifications to the preferred embodiments are provided for by the present invention, which is limited only by the following claims.

What is claimed:

1. A transaction method comprising:
receiving from a buyer an offer to buy at a price, reduced price, or minimum discount level for a product or service on a network;
receiving a response from a seller with a counter-offer of pricing, coupon, discount or promotion on the network;

2. The method of claim 1, wherein the buyer's offer is aggregated with one or more other buyers making an offer to buy on a network in order for the seller to formulate a counter-offer, analytic analysis, or response.

3. The method of claim 1, further comprising
receiving from the buyer an acceptable range of variance from his offer; and
receiving from the seller an acceptable range of variance from his offer.

4. The method of claim 1, further comprising:
polling for, receiving, or compiling information regarding the actual locale of a prospective buyer based upon their locale; and
receiving an offer of pricing, coupon, discount or promotion from a seller based on the information on the network.

5. The method of claim 1, further comprising
polling for, receiving, or compiling information regarding the actual time of a prospective buyer based upon their time zone; and
receiving an offer of pricing, coupon, discount or promotion price from a seller based on the information on the network.

6. A transaction method comprising:
receiving from a seller an offer to sell at a price or discount level for a product or service on a network, wherein the seller's offer is distributed to one or more buyers whose have interest in receiving offers or made a conditional offer to buy the product or service via the network;
receiving from a buyer a counter-offer on a network;
receiving from the seller an acceptable range of variance from the seller's offer; and
receiving from the buyer an acceptable range of variance from the buyer's offer.

7. The method of claim 6, wherein the buyer's offer is aggregated with one or more other buyers making an offer to buy on a network in order for the seller to formulate a counter-offer, analytic analysis, or response.

8. The method of claim 6, further comprising
receiving from the buyer an acceptable range of variance from his offer; and
receiving from the seller an acceptable range of variance from his offer.

9. The method of claim 6, further comprising
polling for, receiving, or compiling information regarding the actual locale of a prospective buyer based upon their locale; and
receiving an offer of pricing, coupon, discount or promotion from a seller based on the information on the network.

10. The method of claim 6, further comprising
polling for, receiving, or compiling information regarding the actual time of a prospective buyer based upon their time zone; and
receiving an offer of pricing, coupon, discount or promotion price from a seller based on the information on the network.

11. A transaction method comprising:
polling for, receiving, or compiling information regarding buyers' profile, device type, and buyer-stated stated price, requested percentage discount, minimum discount level, conditions, or delivery factors for a product or service on a network; and
receiving an offered price from a seller based on the information on the network.

12. The method of claim 11, wherein the buyer's offer is aggregated with one or more other buyers making an offer to buy on a network in order for the seller to formulate a counter-offer, analytic analysis, or response.

13. The method of claim 11, further comprising
receiving from the buyer an acceptable range of variance from his offer; and
receiving from the seller an acceptable range of variance from his offer.

14. The method of claim 11, further comprising
polling for, receiving, or compiling information regarding the actual locale of a prospective buyer based upon their locale; and
receiving an offer of pricing, coupon, discount or promotion from a seller based on the information on the network.

15. The method of claim 11, further comprising
polling for receiving, or compiling information regarding the actual time of a prospective buyer based upon their time zone; and
receiving an offer of pricing, coupon, discount or promotion price from a seller based on the information on the network.
